(19) United States
(12) Patent Application Publication
(10) Pub. No.: US 2022/0230234 A1
(43) Pub. Date: Jul. 21, 2022

(54) RENT TO OWN TRANSACTION SYSTEM

(71) Applicant: Rent-A-Center West, Inc., Plano, TX (US)

(72) Inventors: Ann Davids, Frisco, TX (US); Mohammad Saleh, Frisco, TX (US)

(73) Assignee: Rent-A-Center West, Inc., Plano, TX (US)

(21) Appl. No.: 17/576,460

(22) Filed: Jan. 14, 2022

Related U.S. Application Data
(60) Provisional application No. 63/138,010, filed on Jan. 15, 2021.

(51) Int. Cl. G06Q 30/06

(52) U.S. Cl. CPC G06Q 30/0645; G06Q 30/0639; G06Q 30/0641

(57) ABSTRACT

A rent-to-own (RTO) transaction system and method includes a customer computer and retail computer. A product inventory is displayed on the customer computer, and a product selection is made by a customer via the customer computer. Identifying information is received from the customer, and based thereon, the identity of the customer is verified. An RTO agreement based on the product selection and the identifying information is developed and displayed on the customer computer. An execution of the RTO agreement is made by the customer via the customer computer and received by the retail computer.

### CROSS-REFERENCE TO RELATED APPLICATION

This application claims the benefit of U.S. Provisional Patent Application No. 63/138,010, filed on Jan. 15, 2021, which is incorporated reference in its entirety.

### BACKGROUND

This disclosure relates to systems and methods for rent-to-own (RTO) execution through an ecommerce transaction.

Rent-to-own (RTO) is a type of transaction where items such as furniture, consumer electronics, home appliances, real property, mobile phones, and the like are rented or leased in exchange for periodic rental payments, with an option to purchase at some point during the agreement. Typically, the lessee can purchase the leased item at any time during the agreement, and can terminate the agreement by simply returning the property. Moreover, in some RTO transactions, the customer can make the periodic payments on the merchandise for a pre-specified period of time, at which point they would own the good outright. Many RTO transactions further allow the customer to pay off the remaining balance on the agreement at any point in time in order to obtain permanent ownership of the good.

### SUMMARY

Disclosed example systems and methods relate to an online process for a rent-to-own (RTO) transaction. In accordance with some examples, an RTO transaction system includes a retail computer configured to communicate with a customer computer. A product inventory is displayed on the customer computer, which further receives a product selection by a customer. The retail computer receives identifying information from the customer via the customer computer, and the identity of the customer is verified based on the received identifying information. An RTO agreement based on the product selection and the identifying information is created by the retail computer, and the RTO agreement is displayed on the customer computer, whereby an execution of the RTO agreement by the customer via the customer computer is received by the retail computer.

In accordance with further examples, an RTO transaction system includes a customer computer configured to communicate with a retail computer associated with an RTO store. The customer computer displays a user interface and receives identifying information regarding a customer via the user interface display. The identifying is transmitted information to the retail computer. The customer computer displays on the user interface an indication of an identification of the customer from the retail computer that is based on the transmitted identifying information. A product inventory is received from the retail computer and displayed on the user interface. A product selection is received via the user interface and transmitted to the retail computer. The user interface then displays an RTO agreement received from the retail computer based on the product selection and the identifying information, and an execution of the RTO agreement is received via the user interface, then transmitted to the retail computer. Product delivery instructions are received via the user interface and transmitted transmit to the retail computer.

In accordance with still further disclosed aspects, an RTO transaction method includes communicating with a remote customer computer, determining a geographical location of the customer computer, and displaying a product inventory on the customer computer based on the determined geographical location. A product selection and identifying information from the customer are received via the customer computer. The identity of the customer is verified based on the received identifying information. An RTO agreement based on the product selection, the identifying information, and the financial information is displayed on the customer computer, and the RTO agreement is executed via the customer computer. Product delivery information is provided, and the product is delivered based on the received product delivery information.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram illustrating an example of a rent-to-own (RTO) transaction system.

FIG. 2 is a block diagram illustrating an example of a computer system suitable for use in the RTO transaction system shown in FIG. 1.

FIG. 3 is a flow diagram illustrating an example of an RTO transaction process.

FIG. 4 is a block diagram illustrating an example of a geographic location process.

FIG. 5 is a block diagram illustrating an example of a product browsing process.

FIG. 6 is a block diagram illustrating an example of a risk analysis process.

FIG. 7 is a user interface screenshot illustrating an example of a verification interface.

FIG. 8 is a user interface screenshot illustrating an example of a customer approval notification.

FIG. 9 is a user interface screenshot illustrating an example of a customer denial notification.

FIG. 10 is a user interface screenshot illustrating an example of a customer conditional approval.

FIG. 11 is a block diagram illustrating an example of a checkout process.

FIG. 12 is a user interface screenshot illustrating an example of RTO agreement information.

FIG. 13 is a user interface screenshot illustrating an example of an RTO agreement signing trigger.

FIG. 14 is a user interface screenshot illustrating an example of an RTO agreement execution verification.

FIG. 15 is a block diagram illustrating an example delivery process.

FIG. 16 is a flow diagram illustrating example transaction paths for an RTO transaction process.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In a rent-to-own (RTO) transaction, items such as furniture, consumer electronics, home appliances, real property, mobile phones, and the like are rented or leased in exchange for periodic rental payments (e.g. weekly or monthly), with an option to purchase at some point during the agreement. Typically, the lessee can purchase the leased item at any time during the agreement, and can terminate the agreement by simply returning the property. The RTO process usually involves a customer shopping for goods at a retail store or through web sites or mobile shopping applications. Once the product selection has been made, the customer completes the lease application process at the retail store.

Aspects of this disclosure relate to RTO transactions that may be entirely or nearly entirely completed through an e-commerce system, including disbursement of funds and signing of contractual agreements between the involved parties. More specifically, example implementations include a customer initiating an RTO transaction with or without selecting product(s), with the intent to conduct business with an RTO company through an e-commerce transaction. This simplifies the RTO process for the customer, often eliminating the requirement for the customer to shop at a retail store, and/or visit such a retail establishment to complete the RTO transaction and take possession of the goods.

Such RTO transactions may involve several steps and processes and use systems from the customer side (e.g. home computers, laptop computers, tablet devices, mobile phones, etc.) and the RTO company side (e.g. point-of-sale systems, retail store computers, servers, etc.) to establish geographic location identification, product selection and associated product inventory counts, risk and decision analyses, checkout processes, appropriate initial payments to secure the parties' intent of the RTO transaction, signing of RTO contractual agreements, product delivery, etc.

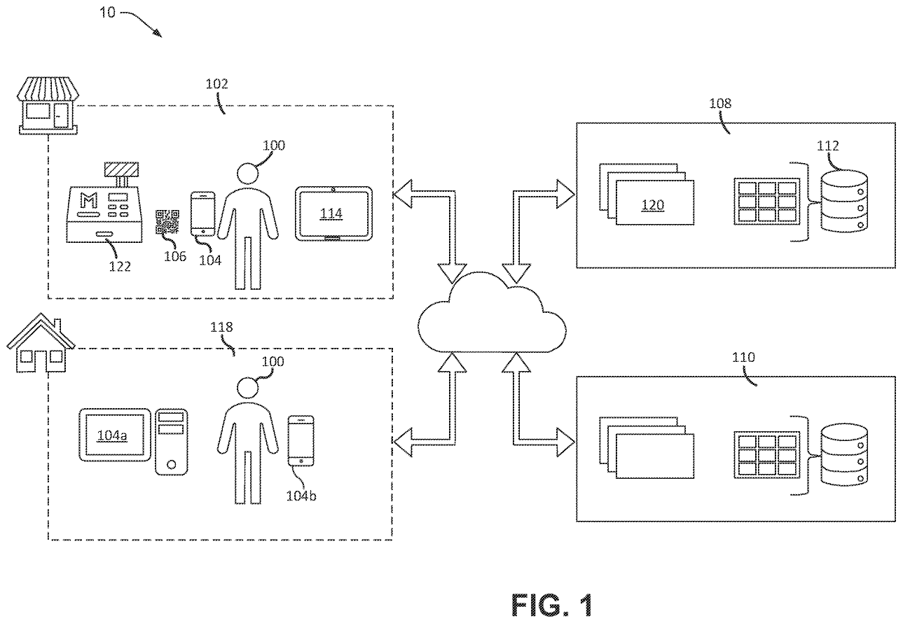

FIG. 1 depicts an embodiment of an RTO transaction system suitable for implementing various principles disclosed herein. Various methods, apparatuses and systems are presented, and are discussed with reference to an RTO company that offers RTO or lease-to-own (LTO) arrangements to customers. In general, RTO and LTO are used interchangeably herein. An RTO arrangement is but one example of a transaction in which the methods, apparatuses and systems disclosed herein are useful.

FIG. 1 depicts a consumer or customer 100 and a retailer 102, such as an RTO retailer. In the situation depicted by FIG. 1, the customer 100 is desirous of acquiring a product offered by the RTO retailer 102 via an RTO agreement. FIG. 1 illustrates the customer 100 in different scenarios, including the customer being located at the retailer 102 establishment and the customer being located at a location 118 remote from the retailer 102, such as at the home of the consumer. FIG. 1 illustrates examples of a customer computing device including a computer 104a such as a desktop or laptop computer, and a mobile device 104b such as a smart phone or tablet (collectively referred to as the customer computer 104). Other consumer computers are within the scope of the disclosure.

The customer 100 may access a website via the customer computer 104, and/or the customer computer 104 may include and app to access capabilities permitting the user to conduct some or all of the functions involved in various shopping and RTO transactions discussed herein. For the sake of clarity, this website and/or app may be referred to herein as the “RTO” website or app where confusion may arise as to which particular website or app is being referred to. Such a website or app may be published by an RTO company offering RTO arrangements to customers. In some instances, the customer 100 may not have the app installed on his device 104. According to some embodiments, a barcode 106, such as a matrix barcode (example: a QR code) may be printed on an item or surface within the establishment 102, along with an instruction that informs the customer 100 that scanning the barcode 106 with the camera integrated within the smart device 104 will result in a web browser installed on the device navigating to a site wherein the app may be downloaded. According to this embodiment, the barcode 106 encodes a universal resource locator (URL) associated with a webpage wherein the user may initiate the process of downloading the aforementioned app. According to some embodiments, the particular app accessed by the customer 100 to scan the barcode (example: a “camera app”) accesses capabilities exposed via the operating system of the device 104 to recognize and respond to the presence of a barcode in the visual data captured by the camera. The executable code providing these capabilities may be dynamically linked into the app's code space. The barcode 106 may also include information causing an app on the smart device (example: an “app store” app) to launch and open to a screen on which the app is available for download. According to other embodiments, the retailer 102 may provide written or oral instructions directing the customer 100 to download the app as a precondition to entry into an RTO transaction.

The RTO website and app (collectively referred to as the RTO app for brevity) communicate and interoperate with a backend system 108 operated by or on behalf of an RTO company extending RTO arrangements. The backend system 108 may, according to some embodiments, communicate with additional computer system(s) 110 to provide the various functions involved in creating and managing an RTO arrangement. The backend system 108 additional computer system(s) 110 shown in FIG. 1 are shown as being located remotely from the retail establishment 102, though these computer systems could be implemented by computer systems located at the retail establishment 102. In general, the RTO app, backend system 108 and additional external systems 110 cooperate to implement various shopping and RTO processes discussed herein.

According to some embodiments, the retail location or store 102 is outfitted with a terminal 114, such as a computer or tablet. The terminal 114 may have the RTO app and/or other software installed to cause it to operate similarly to the customer computer 104. For example, the terminal 114 may be operated by personnel of the RTO company and/or made available for use by the customer 100 when located at the retail store 102. The retail store 102 may further include a point of sale system 122, which also may communicate with the backend system 108 and additional systems 110. Among other things, the backend system 108 includes a data store 112 storing various information such as product descriptions, inventory information for the retail establishment 102, customer information, RTO agreement information, etc. Processes 120 can interface with the datastore 112, and create, update, and delete information stored therein, among other things.

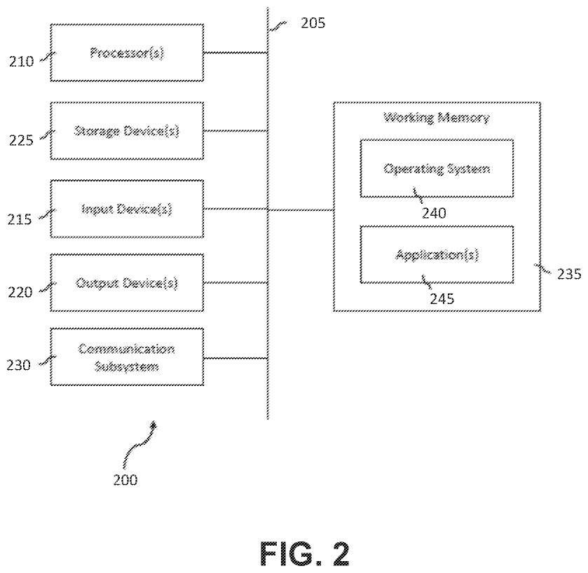

FIG. 2 depicts a schematic illustration of one embodiment of a computer system 200, which can function as a server system, a laptop, tablet, smartphone, a mobile device, including systems such as the customer computer 104, the terminal 114, the backend system 108, the additional systems 110, etc. It should be noted that FIG. 2 is meant only to provide a generalized illustration of various components, any or all of which may be utilized as appropriate. FIG. 2, therefore, broadly illustrates how individual system elements may be implemented in a relatively separated or relatively more integrated manner.

The computer system 200 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input devices 215, which can include without limitation a mouse, a keyboard, touchscreen and/or the like; and one or more output devices 220, which can include without limitation a display device, a printer and/or the like.

The computer system 200 may further include (and/or be in communication with) one or more storage devices 225, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like. The storage devices 225 may be configured to implement the data store 112 shown in FIG. 1, among other things.

The computer system 200 may also include a communications subsystem 230, which can include without limitation a modem, a network card (wireless or wired), an infrared communication device, a wireless communication device and/or chipset (such as a BLUETOOTH™ device, an 802.11 device, a WiFi device, a WiMax device, cellular communication facilities, etc.), and/or the like. The communications subsystem 230 may permit data to be exchanged with a network (such as the network described below, to name one example), other computer systems, and/or any other devices described herein. In many embodiments, the computer system 200 will further comprise a working memory 235, which can include a RAM or ROM device, as described above.

The computer system 200 also can comprise software elements, shown as being currently located within the working memory 235, including an operating system 240, device drivers, executable libraries, and/or other code, such as one or more application programs 245, which may comprise computer programs provided by various embodiments, and/or may be designed to implement methods, and/or configure systems, provided by other embodiments, as described herein. Merely by way of example, one or more processes such as the RTO app and web site discussed herein might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 225 described above. In some cases, the storage medium might be incorporated within a computer system, such as the system 200. In other embodiments, the storage medium might be separate from a computer system (e.g., a removable medium, such as a compact disc), and or provided in an installation package, such that the storage medium can be used to program, configure and/or adapt a general purpose computer with the instructions/code stored thereon. These instructions might take the form of executable code, which is executable by the computer system 200 and/or might take the form of source and/or installable code, which, upon compilation and/or installation on the computer system 200 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some implementations may employ a computer system (such as the computer system 200) to perform methods in accordance with various disclosed embodiments. According to a set of embodiments, some or all of the procedures of such methods are performed by the computer system 200 in response to processor 210 executing one or more sequences of one or more instructions (which might be incorporated into the operating system 240 and/or other code, such as an application program 245) contained in the working memory 235. Such instructions may be read into the working memory 235 from another computer-readable medium, such as one or more of the storage device(s) 225. Merely by way of example, execution of the sequences of instructions contained in the working memory 235 might cause the processor or processors 210 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 200, various computer-readable media might be involved in providing instructions/code to the processor or processors 210 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 225. Volatile media include, without limitation, dynamic memory, such as the working memory 235. Transmission media include, without limitation, coaxial cables, copper wire and fiber optics, including the wires that comprise the bus 205, as well as the various components of the communication subsystem 230 (and/or the media by which the communications subsystem 230 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor or processors 210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 200. These signals, which might be in the form of electromagnetic signals, acoustic signals, optical signals and/or the like, are all examples of carrier waves on which instructions can be encoded, in accordance with various embodiments of the invention.

The communications subsystem 230 (and/or components thereof) generally will receive the signals, and the bus 205 then might carry the signals (and/or the data, instructions, etc. carried by the signals) to the working memory 235, from which the processor(s) 205 retrieves and executes the instructions. The instructions received by the working memory 235 may optionally be stored on a storage device 225 either before or after execution by the processor(s) 210.

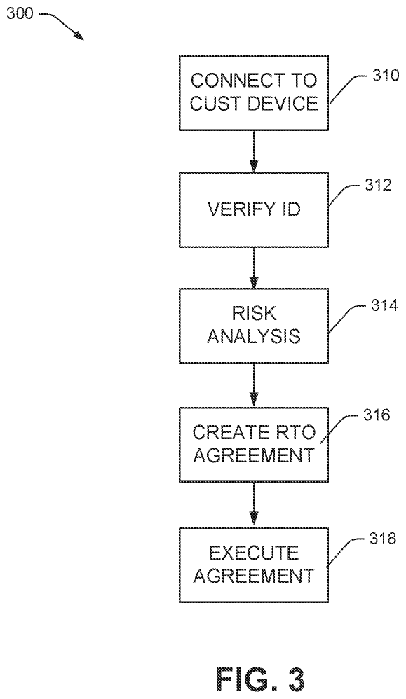

FIG. 3 is a flow diagram illustrating aspects of an RTO transaction process 300 in accordance with some examples. As noted above, in some examples the RTO transaction system may be implemented with the backend system 108 shown in FIG. 1, also referred to herein as the retail computing system or computer 108. FIG. 2 illustrates aspects an example computer system 200 suitable for the backend, or retail computer 108, as well as for the customer computer 104. The computers 104 and 108 thus include the processor(s) 210 and the memory 225/235 communicably connected with and readable by the processor 210. The memory stores instructions that, when executed by the processor 210, cause the retail computer 108 to communicate with the customer computer 104 as indicated in block 310. This may be through a displayed web page and/or the RTO app. Accordingly, in some examples communicating with the customer computer 104 includes displaying a web page user interface on the customer computer 104.

In addition to providing a shopping experience for the customer 100, the interface provided on the customer computer 104 allows the customer to initiate an online order that could result in, for example, a web lead, a product reservation, a denial, or a full online RTO transaction. The customer 100 may select a desired product first, or receive an RTO decision online first. In either scenario, the customer 100 is identified at block 312 through various remote processes. With existing RTO transactions, the customer 100 is simply identified in the retail location 102 by checking a picture ID such as a driver's license. For a completely remote RTO transaction, other identification procedures are employed. Based on the identity verification in block 312, a risk analysis may then be performed in block 314. If the risk analysis at block 314 is satisfactory, the RTO agreement is created as indicated a block 316 by the retail computer 108. The RTO agreement may then be displayed for the customer 100 on the customer computer 104, by which the customer 100 may execute the agreement as indicated at block 318.

As noted above, in various examples the customer 100 may begin the RTO process by selecting a desired product. This process may include a geographic location identification, and product inventory counts associated with retail locations 102 associated with the identified location.

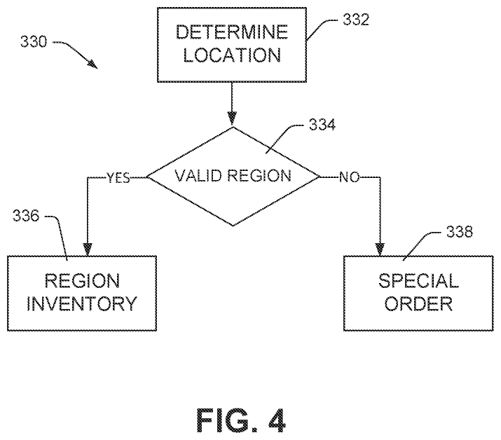

FIG. 4 illustrates example process steps associated with a geographic location process 330. Once the retail computer 108 communicates with the customer computer 104 and identifies the customer as indicated in blocks 312 of FIG. 3, the consumer location is identified at block 332. Location identification may be accomplished through various process and provide varying ranges of precision dependent upon the consent of the customer 104. For instance, GPS processes may be used for location identification, or the customer 104 can simply enter his or her address or zip code. The location information is mapped against proprietary regions by the retail computer 108 and reflected appropriately to the consumer 100 on the customer computer 104. The closest region may be selected by the customer 104 or automatically tied to the closest region. In some examples, products leased to the customer 100 may be supplied directly from the retail location 102. In this situation, if a valid region is selected as determined in block 334, inventory corresponding to that region will be pulled from the retail system 108 and displayed accordingly to the consumer computer 104 as shown in block 336. Inventory counts may further be displayed at block 336. If there is not a valid region association, special order information may be provided at block 338, for instance, a direct ship option to consumer may be available in the determined location. In other examples, stock may be supplied from a centralized warehouse. In such situations, the geographical location information may be used to determine if products are able to be shipped to the customer 100.

Various additional options are available for displaying available products as indicated in blocks 336 and/or 338. For instance, multiple retail stores 102 may be located within an identified region (block 334). One store 102 may be designated as the “home” store based on factors such as proximity to the customer 100 or size of the store. If the home store does not have certain products in stock, another store in the region could provide the product based on an “internal” product transfer. In other embodiments, arrangements are made with outside suppliers to provide products that may be shipped directly to customers or to a designated retail store 102. Thus, products identified in block 336 may be based on availability in the identified region, not necessarily only what is available at particular store(s) in the region.

Different geographical location processes may be employed in the process 330 shown in FIG. 4. For instance, the location determination 332 may be made using GPS, IP address information, or other location algorithms, or by the customer selecting a zip code, for example. Once the region is determined and validated in block 334, this information may be used by the retail computer 108 to display relevant inventory to the customer 100. This allows the customer 100 to choose the nearest product(s), which may be displayed by way of delivery lead times and/or cost based on the verified location. Specific stores in the region may display inventory unique to those stores, including both new and used items. Displaying and providing the ability to rent used items in addition to new items through the online medium (i.e customer computer 104) can significantly improve store operational abilities.

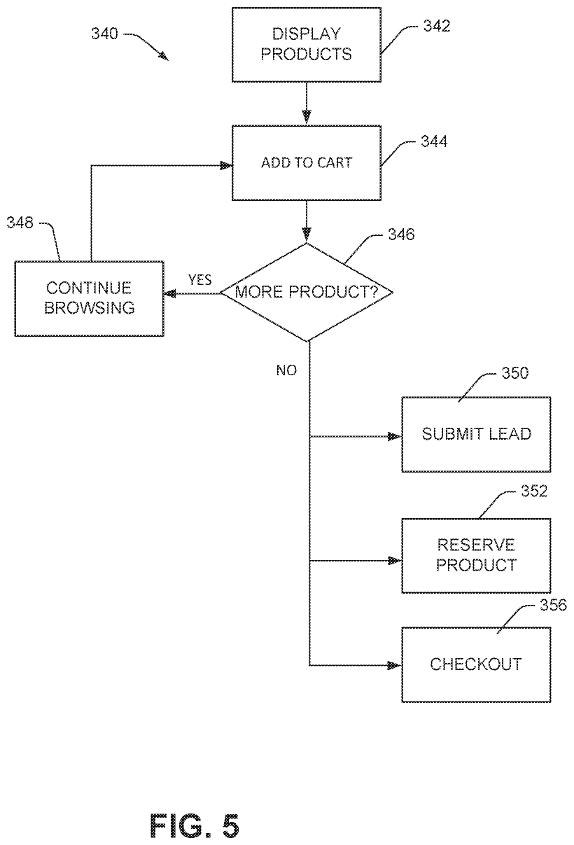

FIG. 5 illustrates an example of aspects of a product browsing process 340. At block 342 products are displayed on the customer computer 104. The displayed products and quantities thereof may be determined in accordance with the process 330 shown in FIG. 4. The displayed products may further include special order products (i.e. not readily available at the local RTO location 102, and are shipped directly from the supplier to the retail store 102 or to the customer 100), or be identified as evergreen (i.e. products that are available for a longer period of time). Special order products may be associated with the identified region.

The customer 100 may choose to add a product to a virtual cart in block 344, which can be performed multiple times to get the desired items into the cart as indicated at blocks 346 and 348. The cart may be saved, wherein the product(s) will be in the cart until they choose to proceed (or the product is no longer available). There are multiple ways that a consumer may proceed following finalizing product selections. A customer 100 may decide to submit a lead in block 350, which may then go through a risk analysis step such as operation 314 of FIG. 3, and then processed by the retail computer 108. A store employee may then coordinate further with the customer.

The customer 100 may also reserve the product in block 352, where an initial payment may be taken but no RTO agreement is completed. The customer 100 may choose to go to the associated store 102 to then sign an RTO agreement, communicate with retail personnel further, continue with the online process at a later time, etc. Still further, the customer 100 may choose to conduct a full checkout and transaction online as indicated in block 356, which allows them to sign the RTO agreement online and pay for the product as well in some examples. This may further include the ability to schedule a delivery to the customer's home 118.

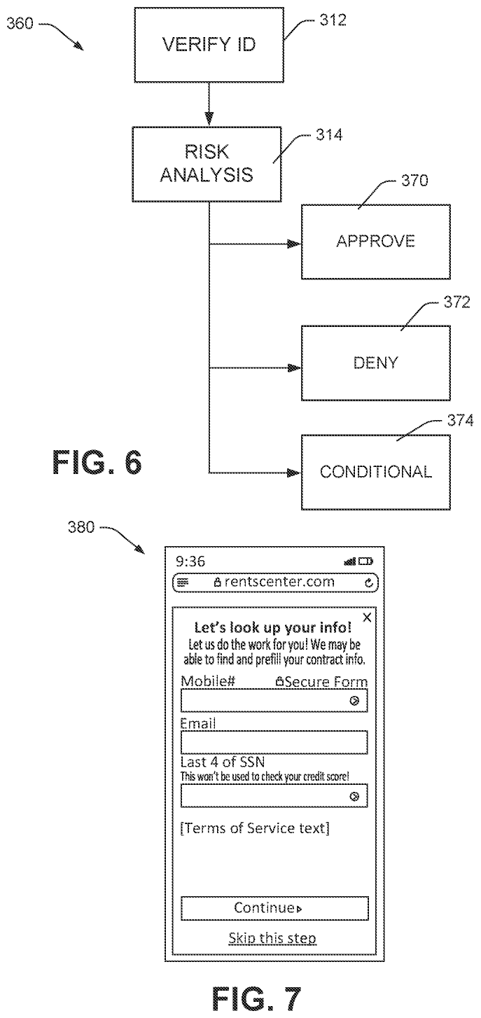

FIG. 6 illustrates aspects of an example a risk analysis process 360. A number of options are provided for the customer to initiate the risk analysis through the customer computer 104, which are communicated to the retail computer 108. The retail computer 108 is configured to processes received information through a superset of various points of data. A recommendation is generated by the retail computer 108, which is then provided back to the customer 100 via the customer computer 104. As noted above, the risk analysis 360 may be conducted subsequent to a product selection using the customer computer 104, or it may occur prior to product selection.

As noted above, the customer 100 identification is verified at block 312, which may be followed by a risk analysis 314 based on the identification process 312. In some examples, these steps may be combined. To ensure the RTO contractual agreement is established with the correct parties, initial checks will protect against various fraudulent actors (e.g. bots or other types) in blocks 312 and 314. FIG. 7 is a screen shot illustrating an example of one verification interface screen 380 displayed on the customer computer 104, such as through the RTO phone app or website. The illustrated example uses a simplified phone number analysis where the customer's phone number, email, and the last four digits of their social security number are entered. This allows a number of additional calculations through the retail computer 108 and/or additional systems 110. The information obtained through the phone number verification may be used to perform a risk analysis 314 to assess the risk associated with the customer identification 312 (i.e. is the customer actually the person purported). As noted above, for transactions conducted in person, such as in the retail store 102, identity may simply be verified by checking a photo ID. The process illustrated in FIGS. 6 and 7 provides an online process for identification. Some implementations allow the customer to select remote processes for identification verification other than the phone number check. Other identifying information could be provided by the customer 100 to the retail computer 108 (and/or additional systems 110) via input screens on the customer computer 104. The customer 100 may provide, for example, images of photo IDs, personal information, references, etc. via the customer computer 104 that are compared against reference information obtained or stored in the retail computer 108 or in the systems 110 for the identity verification 312 and risk assessment 314.

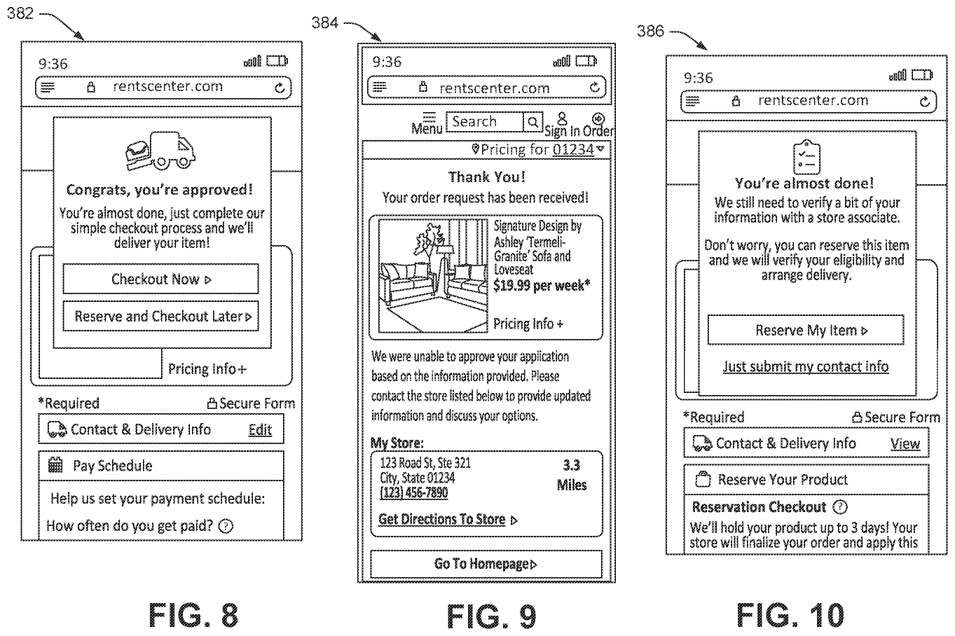

Various decisions may result from the identity verification 312 and risk analysis 314. FIG. 6 illustrates three examples, including approval 370, where the customer 100 is provided an approved monetary amount. An example of an approval user interface screen 382 is shown in FIG. 8. The approved amount may be used for RTO transactions including products in the customer's cart, or may be used for future product selections made via the customer computer 104 and/or in the retail store 102. A customer 100 may alternatively receive a denial 372 from the risk analysis at which point, they are provided the appropriate information. FIG. 9 illustrates an example of a user interface screen 384 providing denial information. Still further, a customer 100 may receive a conditional approval 374, which requires additional steps of validation. Such additional steps may be accomplished by the customer 100 contacting or visiting the associated retail store 102. FIG. 10 illustrates an example of a conditional approval interface screen 386, notifying the customer 100 that additional verification is required, and that the selected item can be reserved.

In some examples, the identity verification process 360 uses a mixture of proprietary data stored, for example, in the data store 112 and executed by the processes 120 together with multiple additional data feeds provided from the additional systems 110 for risk analysis assessment process 314. Because of the improved identification verification 312 and risk analysis 314, the consumer may be provided with a weekly rate for rental payments, for example. This improves both the consumer's ability to determine a weekly financial impact, as well as from the retail store perspective as the weekly rate is often a primary method utilized within the store 102. Operationalizing that through the online experience, simplifies and provides consistency and reduces the risk of RTO transactions.

Moreover, the risk assessment process 314 is used in some embodiments to determine what product inventory is displayed on the customer computer 104 in the product display process 342 of FIG. 5. For instance, special order products or products supplied by partner stores (i.e. not necessarily related to the retail store 102) are only displayed for customers meeting a certain risk level as determined in the risk analysis process 314.

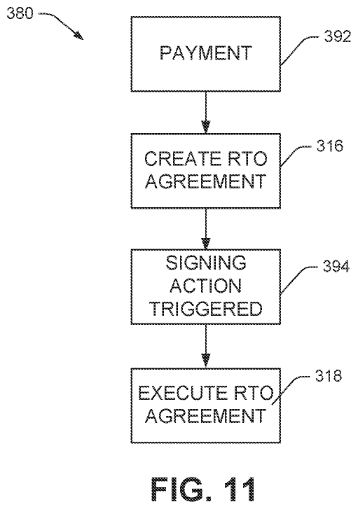

FIG. 11 illustrates aspects of a checkout process 390 including further steps associated with the RTO agreement creation 316 and execution (i.e. signing) process 318 discussed above. Following an initial payment at block 392, a digital RTO agreement is generated by the retail computer 108 displayed on the local customer computer 104, which is followed by a signing event from the consumer. Data is collected, aggregated and appropriate terms are displayed to the consumer computer 104. The customer 100 may then indicate approval, triggering a signing action 394. Subsequently, the RTO agreement is executed at block 318. In some embodiments, the initial payment may occur post agreement signing.

FIG. 12 depicts an example of a user interface screen 396 including RTO agreement data that may be displayed for the customer 100 on the customer computer 104. The example of FIG. 12 displays information such as rental details, purchase option information, benefits options, etc. It is noted that in certain disclosed embodiments, a consumer 100 is provided multiple different payment frequencies to choose from. In the user interface 396 shown in FIG. 12, a monthly payment frequency is employed. However, the improved processes disclosed herein facilitate the use of other payment frequencies such as weekly, bi-weekly, bi-monthly, etc. This provides a benefit to the consumer 100, allowing the customer 100 to choose which frequency best fits him or her, in turn resulting in more consistent payments to the store 102. This can reduce the overall financial impact to the store.

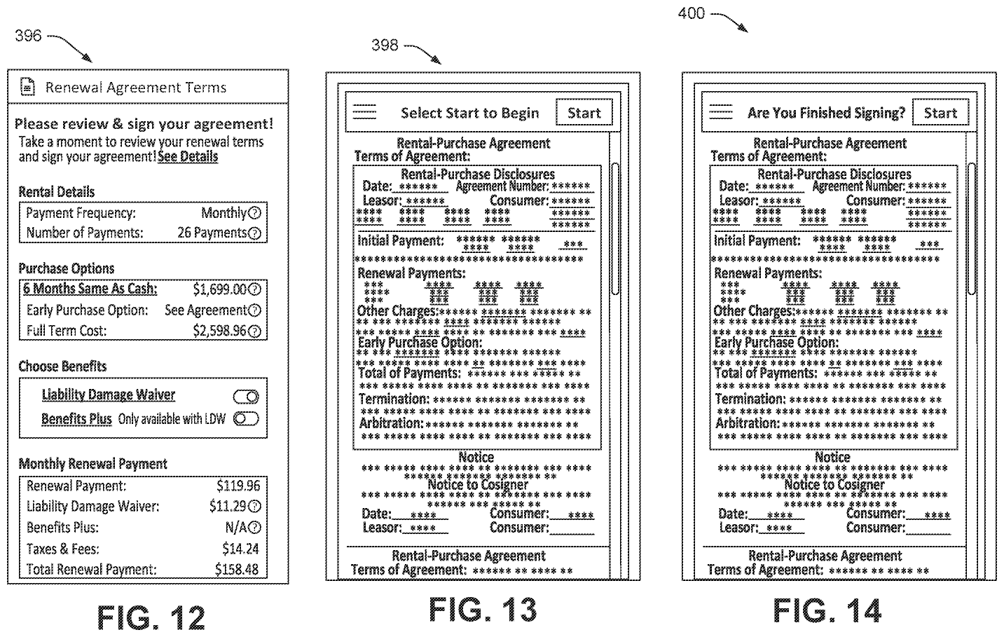

After review of the RTO agreement information, the RTO agreement itself may be displayed on the customer computer 104, and the customer 100 may trigger the signing action 394 by clicking the “start” button shown in the interface screen 398 shown in FIG. 13. In response to the signing action trigger 394, an electronic signature may be obtained as indicated in block 318 using the example interface screen 400 shown in FIG. 14. Completion of execution of the RTO agreement may be indicated by clicking the “finish” button shown in FIG. 14.

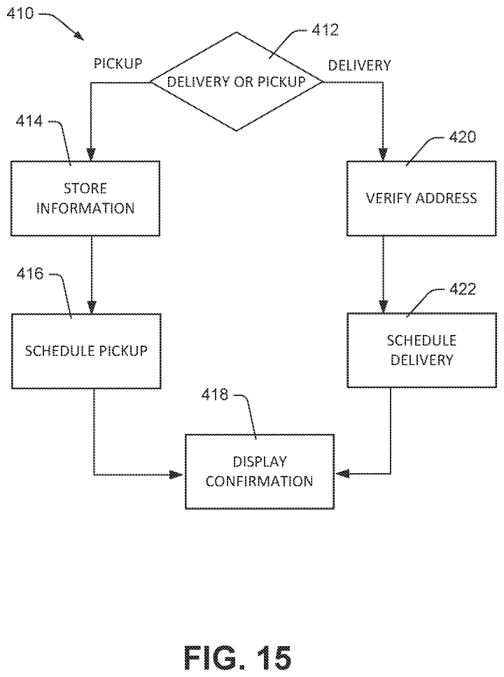

FIG. 15 illustrates example aspects of a process 410 for delivery of products associated with the RTO agreement. The consumer 100 is provided options of pick up or scheduling a delivery in block 412. Upon choosing pickup, the store information is displayed at block 414 so the customer 100 can confirm the store address for pickup location, followed by the scheduling a date and time for pickup at block 416. Once the consumer has confirmed, a confirmation page 418 may be displayed on the customer computer 104.

If the customer 100 chooses delivery of the product in block 412, then the delivery address may be verified in block 420 followed by scheduling the desired date and time for delivery in block 422. After the selection is complete, the confirmation page 418 is displayed on the user computer 104. It is noted that, as discussed in conjunction with the geographic location process 330 of FIG. 4, the initial location determination process may include automated location procedures (e.g. GPS, IP address location, triangulation, etc.) or by manual entry by the customer 100. In some embodiments, while the initial geographic location determination 332 may be made by an automated process, the actual products to be delivered using the delivery process 410 are based on the verified delivery address 420 or the store address 414.

In some embodiments, the risk assessment process 314 shown in FIG. 6 is additionally used to determine aspects of product delivery and shipping to a customer 100. For instance, a delivery choice in block 412 could only be allowed for customers 100 meeting some predetermined risk level as determined in the risk assessment process 314. For a customer 100 who does not satisfy the predetermined risk level, only store pickup is allowed at block 412.

For special order products or products supplied by partner stores (i.e. not necessarily related to the retail store 102), such products are only displayed for customers meeting a certain risk level as determined in the risk analysis process 314.

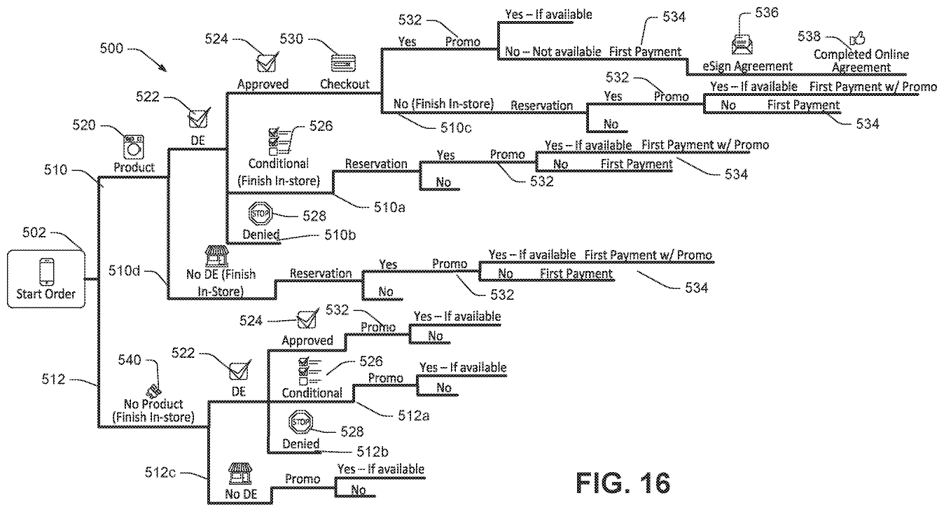

FIG. 16 is a flow diagram illustrating an example process 500 illustrating various paths the customer 100 may take in the RTO transaction process 500. The consumer 100 can start an online order as indicted at block 502, which can progress to web lead (i.e. signal for the retail store 102 to follow up), a product reservation, a denial, or an RTO transaction completed entirely online. Following the order start 502, customer may take an upper path 510 of initially selecting a product via the customer computer 104, or a lower path 512 of first getting an RTO decision.

Referring to the upper path 510, a product 520 is selected. Selection of the product 520 may be in accordance with the processes illustrated in FIGS. 4 and 5 discussed above. Upon selection of one or more products 520 (i.e. products are placed in the virtual cart), information is provided for the approval process to arrive at a decision 522. The approval process may proceed along the lines discussed in conjunction with FIGS. 5 and 6. Upon an approval 524, which may correspond to the approval 370 shown in FIG. 6, the customer 100 may choose to proceed further to the checkout process 526, allowing for a payment mechanism and RTO agreement creation. As also discussed in conjunction with FIG. 6, the approval process resulting from the identity verification 312 and risk analysis 314 may further include a denial 372 and a conditional approval 374.

FIG. 16 illustrates an example of a conditional approval 526, in which the customer 100 is notified to finish the RTO transaction at the retail store 102. The conditional approval 526 results in an additional path 510a branching off the upper path 510. FIG. 16 further illustrates a denial 528, forming a further path 510b branching off the upper path 510.

Continuing with the top path 510, the customer 100 may choose to proceed further to the online checkout process 530, allowing for a payment mechanism and RTO agreement creation as discussed in accordance with FIGS. 11-14. If the customer 100 chooses to continue with the online checkout process 530, the top path 510 continues by determining whether any promotions 532 exist that are associated with the order 502. If a promotion 532 is available, it may be applied to the initial payment 534. If no promotions are applicable, information regarding the first payment 534 is displayed for the customer 100 and the payment is collected as discussed above in conjunction with FIG. 11. The RTO agreement 536 is then created and executed, resulting in the completed RTO agreement 538. Thus, as shown in the top path 500 of FIG. 16, the RTO agreement 536 may be completed entirely online with the customer 100 located remotely from the retail location 102 if desired.

Referring back to the checkout process 530 of the top path 510, the customer may choose not to complete the online process 530, resulting in another path 510c branching off the top path 510. The path 510c allows the customer 102 to reserve the selected product(s) and complete the transaction in the retail store 102. If there is no reservation, the path 510c ends. If a reservation has been made, since the customer has already been approved 524 for an RTO transaction the checkout process continues in the retail store 102, including determining whether a promotion 532 is available, and receiving the initial payment 534 with or without a promotion 532. The RTO agreement may then be completed in the retail store 102.

Similarly, the path 510a requires completing the transaction in the retail store 102. Assuming the conditional approval 526 is satisfied upon the customer 100 visiting the retail store 102, the process may continue in the store 102. If the selected product 520 was reserved during the online shopping process, the checkout process may continue with determining whether a promotion 532 is available, and receiving the initial payment 534 with or without a promotion 532. The RTO agreement may then be completed in the retail store 102.

Referring back to the product selection 520 and subsequent decision process 522 of the upper path 510, the customer may alternatively decide not to complete the decision process 522. For example, rather than provide the information for the identity verification 314 and risk analysis 314 of FIG. 6, the customer 100 skip the decision process 522 and continue on yet another path 510d branching off the upper path 510. The path 510 is also completed in the retail store 102 and proceeds similarly to the path 510a.

FIG. 16 also illustrates a lower path 512 where the customer 102 chooses not to select a product through the online shopping process discussed in conjunction with FIGS. 4 and 5. In the event of such a “no product” start 540, the customer may still complete the online decision process 522. As noted above, information is provided for the approval process to arrive at a decision 522. The decision process 522 may proceed along the lines discussed in conjunction with FIGS. 5 and 6. Upon an approval 524, which may correspond to the approval 370 shown in FIG. 6, the customer 100 would not proceed to the checkout process 526, since no product(s) have yet been selected. However, the path 512 may include determining whether a promotion 532 would apply to the transaction. Thus, as shown in the lower path 512, the decision process 522 may be completed entirely online. The customer 100 may then shop online using the RTO app or web page on the customer computer 104, or select products in the retail store 102. In some examples, details regarding the approval 524 such as approved total rental amounts, payment amounts, etc. may be displayed on the customer computer 104 for the customer 100 for use in selecting appropriate products.

As also noted above, the decision process 522 of the lower path 512 may also include a denial 372 or a conditional approval 374 as shown in FIG. 6. In FIG. 16, the conditional approval 526 for the lower path 512 results in an additional path 512a branching off the main lower path 512. As with the upper path 510, the path 512a corresponding to the conditional approval results in the customer 100 being notified to finish the decision process at the retail store 102. The conditional approval 526 results in an additional path 510a branching off the upper path 510. The denial 528 forms a further path 512b branching off the lower path 512. Still further, the customer may alternatively decide not to complete the decision process 522 of the lower path 512, resulting in another path 512c branching off the lower path 512. Since the path 512c does not include either a product selection 520 or the decision process 522, the transaction process is effectively suspended, though any applicable promotions may be identified.

Thus, as shown in FIG. 16, disclosed processes allow the customer 100 to seamlessly transition between online and store shopping experiences with appropriate preapprovals (resulting from the decision process 522). Such preapprovals, for example, may streamline the RTO shopping experience for the customer 100. In some embodiments, at the start of the order 502, the customer 100 may log into a predetermined customer account. If the customer previously completed the decision process 522 as discussed above, such information may immediately be displayed for the customer on the customer computer 104. This log in process may also be used for RTO shopping in the retail store 102, using the point of sale system 122 and/or the in-store terminal 114. Upon product selection, the customer may complete the checkout process as shown in FIGS. 11-14, as well the product delivery process 410 of FIG. 15.

It is further noted that upon completion of the RTO agreement 538, subsequent rental payments may be made by the customer via the user computer 104. This may provide more consistent and regular payments from the customer 100, whether the RTO transaction was conducted online, in the retail store 102, or through a combination thereof.

Still further, the identification verification process 360 and checkout process 390 using the customer computer 104 (especially the mobile device 104b) or the terminal 114 may be used in conjunction with an RTO process completed in the retail store 102. This standardizes the identification verification process 360 and checkout process 390, providing consistency between online and in-store RTO transactions.

The foregoing outlines features of several embodiments so that those ordinary skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A rent-to-own (RTO) transaction system, comprising:
a retail computer including a processor and a memory communicably connected with and readable by the processor, the memory containing instructions that, when executed by the processor, cause the processor to:
communicate with a customer computer;
transmit a product inventory for display on the customer computer;
receive a product selection via the customer computer;
receive identifying information of a customer via the customer computer;
verify the identity of the customer based on the received identifying information;
create an RTO agreement based on the product selection and the identifying information;
transmit the RTO agreement for display on the customer computer; and
receive an execution of the RTO agreement by the customer via the customer computer.

2. The system of claim 1, wherein verifying the identity of the customer includes comparing the received identifying information to predetermined verification information.

3. The system of claim 1, wherein the wherein the memory contains instructions that, when executed by the processor cause the retail computer to perform an identity risk assessment based on the identifying information.

4. The system of claim 1, wherein the memory contains instructions that, when executed by the processor, cause the processor to determine a location of the customer computer.

5. The system of claim 4, wherein displaying the product inventory includes displaying the product inventory associated with the determined location of the customer computer.

6. The system of claim 5, wherein displaying the product inventory includes displaying the product inventory associated with a retail store located in a region including the determined location of the customer computer.

7. The system of claim 5, wherein displaying the product inventory includes displaying special order products associated with the determined location of the customer computer.

8. The system of claim 4, wherein determining the location of the customer computer includes receiving a location indication via the customer computer.

9. The system of claim 1, wherein displaying the product inventory includes displaying new products and used products.

10. The system of claim 1, wherein the memory contains instructions that, when executed by the processor, cause the processor to receive product delivery instructions via the customer computer.

11. The system of claim 1, wherein verifying the identity of the customer includes determining if the customer has an account based on the received identifying information.

12. A rent-to-own (RTO) transaction system, comprising:
a customer computer including a processor and a memory communicably connected with and readable by the processor, the memory containing instructions that, when executed by the processor, cause the processor to:
communicate with a retail computer associated with an RTO store;
display a user interface;
receive identifying information regarding a customer via the user interface display;
transmit the identifying information to the retail computer;
display on the user interface an indication of an identification of the customer from the retail computer based on the transmitted identifying information;
display on the user interface a product inventory received from the retail computer;
receive a product selection via the user interface;
transmit the product selection to the retail computer;
display on the user interface an RTO agreement received from the retail computer based on the product selection and the identifying information;
receive an execution of the RTO agreement via the user interface;
transmit the executed RTO agreement to the retail computer;
receive product delivery instructions via the user interface; and
transmit the delivery instructions to the retail computer.

13. The system of claim 12, wherein the memory contains instructions that, when executed by the processor, cause the processor to transmit location information of the customer computer to the retail computer.

14. The system of claim 12, wherein the memory contains instructions that, when executed by the processor, cause the processor to receive account log in information via the user interface.

15. A rent-to-own (RTO) transaction method, comprising:
communicating with a remote customer computer;
determining a geographical location of the customer computer;
displaying a product inventory on the customer computer based on the determined geographical location;
receiving a product selection via the customer computer;
receiving identifying information regarding a customer via the customer computer;
verifying the identity of the customer based on the received identifying information;
creating an RTO agreement based on the product selection and the identifying information;
displaying the RTO agreement on the customer computer;
receiving an execution of the RTO agreement via the customer computer;
receiving product delivery information via the customer computer; and
delivering the product based on the received product delivery information.

16. The method of claim 15, further comprising performing a risk assessment based on the identifying information.

17. The method of claim 16, wherein displaying the product inventory on the customer computer includes displaying the product inventory based on the risk assessment.

18. The method of claim 15, wherein displaying the product inventory on the customer computer includes displaying the product inventory associated with a retail store located in a region including the determined location of the customer computer

19. The method of claim 15, further comprising receiving account log in information via the customer computer.

20. The method of claim 15, wherein displaying the product inventory includes displaying new products and used products.
